(19) United States
(12) Patent Application Publication
(10) Pub. No.: US 2009/0040420 A1
(43) Pub. Date: Feb. 12, 2009

(54) Backlight unit and image display apparatus including the backlight unit

(76) Inventors: Deuk-Seok Chung, Yongin-si (KR); Yong-Chul Kim, Yongin-si (KR); Min-Jong Bae, Yongin-si (KR); Ho-Suk Kang, Yongin-si (KR)

Correspondence Address: ROBERT E. BUSHNELL & LAW FIRM, 2029 K STREET NW, SUITE 600, WASHINGTON, DC, 20006-1004, US

(21) Appl. No.: 12/222,048

(22) Filed: Jul. 31, 2008

(30) Foreign Application Priority Data
Aug. 9, 2007 (KR) 10-2007-0080343

(51) Int. Cl. G02F 1/13357; H01J 63/04

(52) U.S. Cl. 349/61; 313/496

(57) ABSTRACT

In a backlight unit and an image display apparatus including the backlight unit, the backlight unit includes a base substrate and a transparent substrate arranged to face each other; a cathode electrode and a first gate electrode alternately arranged on an upper surface of the base substrate; an emitter arranged on an edge of the cathode electrode facing the first gate electrode; an insulation layer arranged on the cathode electrode and the first gate electrode; a second gate electrode arranged on an upper surface of the insulation layer; and a fluorescent layer arranged on a lower surface of the transparent substrate. An aperture is arranged in the insulation layer and second gate electrode, the aperture being in an area corresponding to the emitter.

### CLAIM OF PRIORITY

This application makes reference to, incorporates the same herein, and claims all benefits accruing under 35 U.S.C. §119 from an application for BACKLIGHT UNIT AND IMAGE DISPLAY APPARATUS EMPLOYING THE SAME earlier filed in the Korean Intellectual Property Office on the 9 Aug. 2007 and there duly assigned Serial No. 2007-0080343.

### BACKGROUND OF THE INVENTION

1. Field of the Invention

The present invention relates to a backlight unit and image display apparatus including the backlight unit, and more particularly, to the present invention relates to a field emission type backlight unit which is capable of increasing luminous efficiency as compared to conventional technology and has a simple structure, and an image display apparatus including the field emission type backlight unit.

2. Description of the Related Art

In general, a flat panel display is widely classified into an emissive type display and a non-emissive type display. For example, the emissive type display includes a Cathode Ray Tube (CRT) display, a Plasma Display Panel (PDP), and a Field Emission Display (FED). The non-emissive type display includes a Liquid Crystal Display (LCD). The LCD is advantageous due to its light-weight and low power consumption. However, the LCD cannot form an image by emitting light from the LCD itself, but forms an image by using an external incident light, and thus, an image cannot be viewed in a dark place.

In order to solve this problem, a backlight unit is installed in the rear of the LCD. A conventional backlight unit generally employs a Cold Cathode Fluorescent Lamp (CCFL) as a line light source, or a Light Emitting Diode (LED) as a point source of light. However, in general, such conventional backlight unit has a complicated structure thereby involving a high manufacturing cost, and since a light source is located at a side of the conventional backlight unit, it has a high power consumption due to the reflection and transmittance of light. In particular, the larger the LCD becomes, the more difficult it is to obtain a uniform brightness.

In order to solve this problem, recently, a field emission type backlight unit having a flat light emitting structure has been developed. The technology related to the field emission type backlight unit mainly employs an FED structure, and the field emission type backlight unit can be formed of a simple diode-type FED, or a triode-type FED in which a gate hole is formed in a substrate. Such a field emission type backlight unit has a low power consumption as compared to the conventional backlight unit employing a CCFL, and has a relatively uniform brightness in a wide light emitting area. However, the field emission type backlight unit formed of the diode-type FED has problems due to the effects of arcing and an anode voltage shield, and also the field emission type backlight unit formed of the triode-type FED has problems due to its complicated structure, thereby incurring a high manufacturing cost.

### SUMMARY OF THE INVENTION

The present invention provides a field emission type backlight unit that is free of problems due to arcing and an anode voltage shield, has a simple structure, and has a low manufacturing cost.

The present invention also provides a field emission type backlight unit with a local dimming capability.

The present invention also provides an image display apparatus employing the field emission type backlight unit.

According to an aspect of the present invention, a backlight unit is provided, the backlight unit including a base substrate and a transparent substrate disposed to face each other; a cathode electrode and a first gate electrode alternately disposed on an upper surface of the base substrate; an emitter formed on an edge of the cathode electrode facing the first gate electrode; an insulation layer formed on the cathode electrode and the first gate electrode; a second gate electrode formed on the upper surface of the insulation layer; and a fluorescent layer formed on a lower surface of the transparent substrate. An aperture is arranged in the insulation layer and second gate electrode, the aperture being formed in an area corresponding to the emitter.

A plurality of the cathode electrodes and first gate electrodes alternating with each other may be disposed along a first direction, the cathode electrodes and the first gate electrodes extending lengthwise in a second direction perpendicular to the first direction.

A pulse voltage may be supplied to the first gate electrodes.

A plurality of the emitters may be formed in the each of the cathode electrodes facing the first gate electrode along the second direction.

The emitters may be formed of carbon nanotubes.

The second gate electrode may be segmented into segments extending lengthwise along the first direction.

A pulse voltage may be supplied to the segments of the second gate electrode.

The backlight unit may further include a diffuser plate disposed facing a surface of the transparent substrate.

The insulation layer may be formed to completely cover the cathode electrode, the first gate electrode, and the base substrate.

The aperture may be formed to expose the emitter, and part of the first gate electrode facing the emitter.

According to another aspect of the present invention, an image display apparatus is provided including a backlight unit having the aforementioned structure; and a display panel forming an image by using light provided by the backlight unit.

The display panel may be a Liquid Crystal Display (LCD) panel.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a schematic cross-sectional view of structure of a backlight unit, according to an embodiment of the present invention;

FIG. 2 is a schematic sectional-perspective view of a structure of a light emitting unit of the backlight unit of FIG. 1; and

FIG. 3 is a schematic cross-sectional view of a structure of an image display apparatus employing the backlight unit of FIG. 1.

### DETAILED DESCRIPTION OF THE INVENTION

The present invention is described more fully hereinafter with reference to the accompanying drawings, in which exemplary embodiments of the present invention are shown.

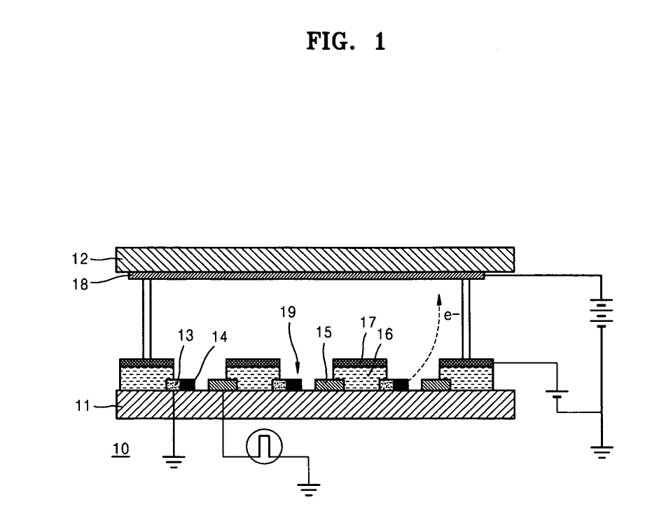

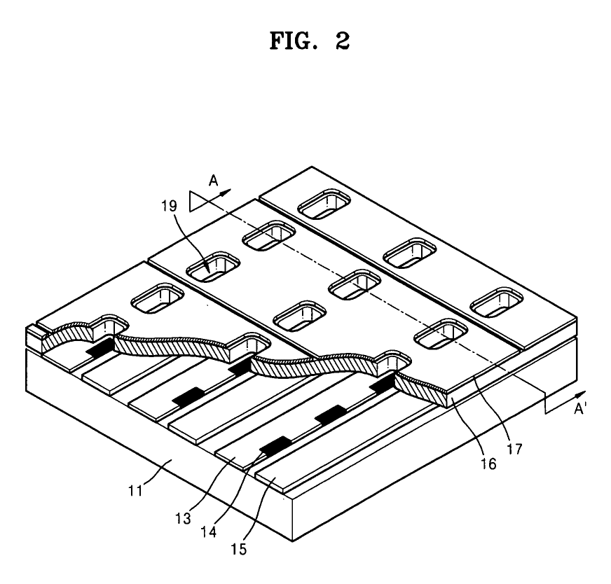

FIG. 1 is a schematic cross-sectional view of a backlight unit 10, according to an embodiment of the present invention, and FIG. 2 is a schematic sectional-perspective view of a structure of a light emitting unit of the backlight unit 10 of FIG. 1. Also, the cross-sectional view of FIG. 1 is taken along line AA′ in FIG. 2.

Referring to FIGS. 1 and 2, the backlight unit 10 according to the present invention includes a base substrate 11 and a transparent substrate 12 which are disposed to face each other, a cathode electrode 13 and a first gate electrode 15 which are alternately disposed on the top surface of the base substrate 11, emitters 14 formed on an edge of the cathode electrode 13 facing the first gate electrode 15, an insulation layer 16 formed on the cathode electrode 13 and first gate electrode 15, a second gate electrode 17 formed on the top surface of the insulation layer 16, and a fluorescent layer 18 formed on the bottom surface of the transparent substrate 12. As illustrated in FIGS. 1 and 2, holes 19 are formed in the insulation layer 16 and second gate electrode 17, the holes 19 being formed in an area corresponding to the emitters 14. Also, although it is not illustrated, an anode electrode is further arranged between the fluorescent layer 18 and the transparent substrate 12.

According to the current embodiment of the present invention, a plurality of the cathode electrodes 13 and the first gate electrodes 15, which are alternately disposed on the base substrate 11, are formed on the base substrate 11 at a regular interval along a first direction. Each cathode electrode 13 and each first gate electrode 15 are formed extending lengthwise along a second direction that is perpendicular to the first direction. Thus, each cathode electrode 13 and first gate electrode 15 are formed as a flat rectangle that has a narrow width and long length, as illustrated in FIGS. 1 and 2.

Also, in each cathode electrode 13, a plurality of the emitters 14 are disposed along an edge of each cathode electrode 13 at regular intervals. The emitters 14 are formed in the cathode electrode 13 facing the first gate electrode 15 along the second direction, whereby the emitters 14 face the first gate electrode 15. The emitters 14 may be formed of carbon nanotubes. For example, the emitters 14 may be formed by patterning carbon nanotubes along the edge of the cathode electrode 13 facing the first gate electrode 15.

Also, as illustrated in FIGS. 1 and 2, the insulation layer 16 may be formed as a single layer on the cathode electrode 13 and first gate electrode 15, so as to completely cover the cathode electrode 13, the first gate electrode 15, and the base substrate 11. For example, the insulation layer 16 may be formed of a glass, and the like. The second gate electrode 17 is completely formed on the top surface of the insulation layer 16. As described above, the holes 19 are formed in the insulation layer 16 and gate electrode 17 in the area corresponding to the emitters 14. In this manner, by forming the holes 19 in the insulation layer 16 and second gate electrode 17, the emitters 14 and the first gate electrode 15 facing the emitters 14 may be partly exposed. Thus, electrons emitted from the emitters 14 may reach the fluorescent layer 18 via the holes 19.

According to the current embodiment of the present invention, by patterning the second gate electrode 17, the second gate electrode 17 is segmented into segments extending lengthwise along the first direction. Thus, as illustrated in FIG. 2, each of the segments of the second gate electrode 17 is disposed in a direction perpendicular to the cathode electrode 13 and first gate electrode 15.

Hereinafter, the operation of the backlight unit 10 having the aforementioned structure according to the present invention is explained in detail.

When a voltage is supplied to the first gate electrode 15 and second gate electrode 17, electrons are emitted from the emitter 14 due to an electric potential difference between the first gate electrode 15 and cathode electrode 13. Such emitted electrons are directed to the outside via the holes 19 to collide with the fluorescent layer 18 by the second gate electrode 17. For this, a bias voltage is additionally supplied to the second gate electrode 17. Thus, the electrons propagating to the outside via the holes 19 collide with the fluorescent layer 18 due to the anode electrode (not shown) between the fluorescent layer 18 and the transparent substrate 12. In this process, light is generated by the fluorescent layer 18 of which fluorescent materials generating white light are used.

Since the backlight unit 10 according to the present invention is a triode-type TFT using two gate electrodes, which are the first and second gate electrodes 15 and 17, and thus, problems due to arcing and an anode voltage shield, which generally occur in a diode-type TFT, can be prevented. Also, as described above, the backlight unit 10 has a simpler structure as compared to a conventional triode-type FET, thereby facilitating its manufacture and decreasing its manufacturing costs.

Additionally, according to the present invention, a pulse voltage may be independently supplied to each of the first gate electrodes 15, and to each of the segments of the second gate electrode 17. In order for electrons to reach and collide with the fluorescent layer 18, a voltage has to be supplied to all of the first and second gate electrodes 15 and 17. Thus, by supplying a voltage to only a part of the first gate electrodes 15 and the segments of the second gate electrode 17, the emission of electrons may be controlled so as to emit light only in a desired area. Thus, the backlight unit 10 according to the present invention has a local dimming capability by being turned off for a part corresponding to a dark part of an image provided from a display panel, thereby enabling a contrast ratio in an interface region between a bright area and a dark area to be increased.

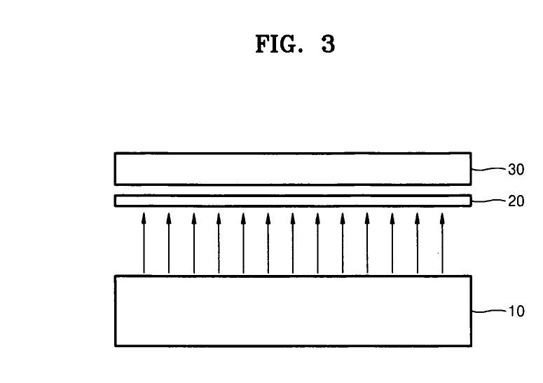

The backlight unit 10 having the aforementioned structure according to the present invention may be employed in an image display apparatus together with a display panel 30, such as a Liquid Crystal Display (LCD) panel, of a light receiving type, as illustrated in FIG. 3.

FIG. 3 is a cross-sectional diagram of a structure of the image display apparatus employing a backlight unit 10 of FIG. 1.

The backlight unit 10 provides light to the display panel 30 in a manner of local dimming, and the display panel 30 forms an image by using the light provided by the backlight unit 10. Additionally, a diffuser plate 20, to cause the light emitted from the backlight unit 10 to be uniform, may be further disposed between the backlight unit 10 and the display panel 30. The diffuser plate 20 is disposed facing a surface of the transparent substrate 12 of the backlight unit 10, and may be included in the backlight unit 10 as a component of the backlight unit 10. As described above, the backlight unit 10 has a local dimming capability, and thus, the image display apparatus may provide an image having an increased contrast ratio.

According to the present invention, by manufacturing a substrate in a simple process, such as a field emission type backlight unit having a diode-type FET, and by installing an additional gate on the substrate, problems due to arcing and an anode voltage shield can be solved. Also, a structure of the field emission type backlight unit according to the present invention is simpler than the conventional triode-type FET, and is capable of being manufactured at a low cost by a simple process.

Also, according to the present invention, by patterning the additional gate, local dimming capabilities of the backlight unit can be achieved. Thus, for example, motion blur and a contrast ratio of an LCD can be improved, power consumption can be decreased, and a lifetime of the backlight unit itself can be improved.

While this invention has been particularly shown and described with reference to exemplary embodiments thereof, it will be understood by one of ordinary skill in the art that various changes in form and details may be made therein without departing from the spirit and scope of the invention as defined by the appended claims. The exemplary embodiments should be considered in a descriptive sense only and are not for purposes of limitation. Therefore, the scope of the present invention is defined not by the detailed description of the present invention but rather by the appended claims, and all differences within the scope will be construed as being included in the present invention.

What is claimed is:

1. A backlight unit comprising:
a base substrate and a transparent substrate arranged to face each other;
a cathode electrode and a first gate electrode alternately arranged on an upper surface of the base substrate;
an emitter arranged on an edge of the cathode electrode facing the first gate electrode;
an insulation layer arranged on the cathode electrode and the first gate electrode;
a second gate electrode arranged on an upper surface of the insulation layer; and
a fluorescent layer arranged on a lower surface of the transparent substrate;
wherein an aperture is arranged in the insulation layer and second gate electrode, the aperture being in an area corresponding to the emitter.

2. The backlight unit of claim 1, wherein a plurality of the cathode electrodes and first gate electrodes alternating with each other are arranged along a first direction, and wherein the cathode electrodes and the first gate electrodes extend lengthwise in a second direction perpendicular to the first direction.

3. The backlight unit of claim 2, wherein a pulse voltage is supplied to the first gate electrodes.

4. The backlight unit of claim 2, wherein a plurality of the emitters are arranged in the each of the cathode electrodes facing the first gate electrode along the second direction.

5. The backlight unit of claim 4, wherein the emitters comprise carbon nanotubes.

6. The backlight unit of claim 2, wherein the second gate electrode is segmented into segments extending lengthwise along the first direction.

7. The backlight unit of claim 6, wherein a pulse voltage is supplied to the segments of the second gate electrode.

8. The backlight unit of claim 1, further comprising a diffuser plate arranged facing a surface of the transparent substrate.

9. The backlight unit of claim 1, wherein the insulation layer is arranged to completely cover the cathode electrode, the first gate electrode, and the base substrate.

10. The backlight unit of claim 1, wherein the aperture is arranged to expose both the emitter and part of the first gate electrode facing the emitter.

11. An image display apparatus comprising:
a backlight unit; and
a display panel forming an image using light emitted by the backlight unit, the backlight unit including:
a base substrate and a transparent substrate arranged to face each other;
a cathode electrode and a first gate electrode alternately arranged on an upper surface of the base substrate;
an emitter arranged on an edge of the cathode electrode facing the first gate electrode;
an insulation layer arranged on the cathode electrode and the first gate electrode;
a second gate electrode arranged on an upper surface of the insulation layer; and
a fluorescent layer arranged on a lower surface of the transparent substrate;
wherein an aperture is arranged in the insulation layer and second gate electrode, the aperture being in an area corresponding to the emitter.

12. The image display apparatus of claim 11, wherein a plurality of the cathode electrodes and first gate electrodes alternating with each other are arranged along a first direction, and wherein the cathode electrodes and the first gate electrodes extend lengthwise in a second direction perpendicular to the first direction.

13. The image display apparatus of claim 12, wherein a pulse voltage is supplied to the first gate electrodes.

14. The image display apparatus of claim 12, wherein a plurality of the emitters are arranged in the each of the cathode electrodes facing the first gate electrode along the second direction.

15. The image display apparatus of claim 14, wherein the emitters comprise carbon nanotubes.

16. The image display apparatus of claim 12, wherein the second gate electrode is segmented into segments extending lengthwise along the first direction.

17. The image display apparatus of claim 16, wherein a pulse voltage is supplied to the segments of the second gate electrode.

18. The image display apparatus of claim 11, further comprising a diffuser plate arranged facing a surface of the transparent substrate.

19. The image display apparatus of claim 11, wherein the insulation layer is arranged to completely cover the cathode electrode, the first gate electrode, and the base substrate.

20. The image display apparatus of claim 11, wherein the aperture is arranged to expose the emitter, and part of the first gate electrode.

21. The image display apparatus of claim 11, wherein the display panel comprises a Liquid Crystal Display (LCD) panel.
